(19) United States
(12) Patent Application Publication
(10) Pub. No.: US 2025/0175906 A1
(43) Pub. Date: May 29, 2025

(54) SYSTEMS AND METHODS FOR ADAPTIVE SENSING POWER CONTROL

(71) Applicant: Huawei Technologies Co., Ltd., Shenzhen (CN)

(72) Inventors: Hao Tang, Ottawa (CA); Wen Tong, Ottawa (CA); Jianglei Ma, Ottawa (CA)

(21) Appl. No.: 19/030,245

(22) Filed: Jan. 17, 2025

Related U.S. Application Data
(63) Continuation of application No. PCT/CN2022/134755, filed on Nov. 28, 2022.

(51) Int. Cl. H04W 52/14; H04W 52/36; H04W 72/231; H04W 72/566

(52) U.S. Cl. CPC H04W 52/146; H04W 52/36; H04W 72/231; H04W 72/566

(57) ABSTRACT

Some aspects of the present disclosure provide an adaptive sensing method that enables separate power control parameter configuration for uplink (UL) communication transmission or sidelink (SL) communication transmission and sensing transmission. When a signal or a channel is used for both communication and sensing, two sets of parameters may be configured, a first set of parameters for UL or SL communication and a second set of parameters for sensing. Some aspects of the present disclosure provide a distributed power control method that involves slow power ramping of a transmitted signal used for sensing. The distributed power control method may also include interference avoidance. Some aspects of the present disclosure provide a centralized power control method that involves, a centralized network side device, such as a base station, sending a signaling to adapt UE power to mitigate interference between UEs when interference is detected.

### CROSS REFERENCE TO RELATED APPLICATION

This application is a continuation of PCT Application No. PCT/CN2022/134755, entitled “SYSTEMS AND METHODS FOR ADAPTIVE SENSING POWER CONTROL,” filed on Nov. 28, 2022, which application is hereby incorporated herein by reference in its entirety.

### TECHNICAL FIELD

The present disclosure relates generally to wireless communications, and in particular to systems and methods for adaptive sensing power control.

### BACKGROUND

In some wireless communication systems, user equipment (UE) wirelessly communicates with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

Sensing may be performed by a UE to obtain information about surroundings of the UE. Sensing allows the UE to detect information of one or more objects, such as, but not limited to, environment information in proximity to the UE, UE location, UE speed, UE orientation and with regard to objects in proximity to the UE, distance to an object and shape of the object. Sensing may involve the UE performing measurements of a signal that is reflected of an object. Measurements may be performed by radio-frequency (RF) sensing, e.g. a radio signal reflects off of an object and is measured by the UE. There are two types of sensing, mono-static sensing and bi-static sensing. For mono-static sensing, the transmitter and the receiver are the same device. For example, the UE sends a RF signal and receives an echo to measure and determine sensing results. For bi-static sensing, the transmitter and the receiver are different devices, e.g. the base station sends sensing signals and the UE receives the echo signals, or vice versa.

Interference may occur when using mono-static or bi-static sensing when multiple UEs are close to each other and are using the same or similar resources (i.e., time, frequency and spatial resources) for sensing transmissions.

Generally, there are two types of solutions for attempting to address interference related problems. With a centralized scheme, a base station allocates sensing resources and a transmit power for each UE. However, this approach may be complicated due to UE movement. With a distributed scheme, the UEs are responsible for communication with one another for allocating sensing resources and transmit power for the UEs in a local area. Such a distributed scheme may also be difficult to coordinate multiple UEs in order to reduce interference.

### SUMMARY

Some aspects of the present disclosure provide an adaptive sensing method that enables separate power control parameter configuration for uplink (UL) communication transmission or sidelink (SL) communication transmission and sensing transmission. When a signal or a channel is used for both communication and sensing, two sets of parameters may be configured, a first set of parameters for UL or SL communication and a second set of parameters for sensing. Providing the use of separate power control parameters for UL or SL communication transmission and for sensing may enable flexible configuration for sensing power control.

Some aspects of the present disclosure provide a centralized power control method that involves, a centralized network side device, such as a base station, sending a signaling to adapt UE power to mitigate interference between UEs when interference is detected. Centralized UE power control that includes the base station forwarding power control information to UEs may enable interference coordination among multiple UEs that are performing sensing.

Some aspects of the present disclosure provide a distributed power control method that involves slow power ramping of a transmitted signal used for sensing. The distributed power control method may also include interference avoidance. Distributed UE sensing power control that includes multiple UEs coordinating power control information between UEs may enable improving spectrum efficiency among multiple UEs that are performing sensing.

According to some aspects of the disclosure, there is provided a method for use by a user equipment (UE) that has both communication and sensing capability, the method involving: receiving, by a UE, a first set of a plurality of power control parameters for determining transmission power of a uplink (UL) communication transmission or a sidelink (SL) communication transmission and a second set of a plurality of power control parameters for determining transmission power of a sensing transmission; determining, by the UE, at least one of: transmission power for an UL communication transmission or SL communication transmission based on the first set of the plurality of power control parameters; or transmission power for a sensing transmission based on the second set of the plurality of power control parameters.

In some embodiments, the UE determines whether to use the first set of the plurality of power control parameters or the second set of the plurality of power control parameters based on receiving an indication to select the first set or the second set.

In some embodiments, the UE determines whether to use the first set of the plurality of power control parameters or the second set of the plurality of power control parameters based on the first and second sets of plurality of power control parameters each being associated with a reference signal resource and when a given reference signal resource is selected, the associated first or second set of the plurality of power control parameters is selected.

In some embodiments, the UE determines whether to use the first set of the plurality of power control parameters or the second set of the plurality of power control parameters based on the first and second sets of plurality of power control parameters each being associated with a resource configuration parameter and when a given resource configuration parameter is selected, the associated first or second set of the plurality of power control parameters is selected.

In some embodiments, the resource configuration parameter is one of a reference signal bandwidth, a number of reference signal ports, a number of reference signal symbols, or a number of physical channel symbols.

In some embodiments, the method further involves determining: transmission power of the UL communication transmission or the SL communication transmission using the first set of the plurality of power control parameters; or transmission power of a sensing transmission using the using the second set of the plurality of power control parameters.

In some embodiments, the UL communication transmission or the SL communication transmission and the sensing transmission is a sounding reference signal (SRS).

In some embodiments, parameters in the first set of parameters are different than parameters in the second set of parameters.

In some embodiments, a parameter or multiple parameters in the second set are dedicated for sensing power control.

In some embodiments, the method is for use in interference avoidance of sensing transmissions involving: receiving, by the UE, an indication for the UE to adjust UE sensing transmission power, wherein the indication is an indication of an absolute sensing transmission power or an indication of a differential sensing transmission power; and adjusting, by the UE, the sensing transmission power based on the indication.

In some embodiments, the indication is received on a UE specific downlink control information (DCI), a group-specific DCI, a media access control-control element (MAC-CE) or a radio resource control (RRC) message.

In some embodiments, the indication includes are least one of: an indication of whether the UE is configured to adjust power control for both of the UL communication transmission or the SL communication transmission and the sensing transmission; or a transmission power command (TPC).

In some embodiments, the method further involves receiving, by the UE, configuration information indicating whether the indication of whether the UE is configured to adjust power control for both of the UL communication transmission or the SL communication transmission and the sensing transmission is included in the indication, and if not included, the indication is for adjusting sensing transmission power.

In some embodiments, the method further involves receiving, by the UE, configuration information pertaining to sensing resources for other UEs.

In some embodiments, the method further involves measuring, by the UE, resources of other UEs.

In some embodiments, the method further involves transmitting, by the UE, a report comprising interference information measured by the UE.

In some embodiments, the method further involves increasing a sensing transmit power, by the UE, by at least one of: exponentially ramping the sensing transmit power; or linearly ramping the sensing transmit power.

In some embodiments, increasing the sensing transmit power is performed by the UE: prior to receiving an indication for the UE to adjust UE sensing transmission power; or after the UE has adjusted UE sensing transmission power by reducing the UE sensing signal transmission power.

In some embodiments, the method is for use in interference avoidance of sensing transmissions involving: receiving, by the UE, configuration information pertaining to sensing resources used by other UEs; when interference is detected from a second UE of the other UEs, comparing a priority of the UE with a priority of the second UE; based on the comparing: if the priority of the UE is higher than the priority of the second UE, transmitting a sensing transmission power reduction request to reduce the transmission power of the second UE; or if the priority of the UE is lower than the priority of the second UE, lower the sensing transmission power of the UE.

In some embodiments, the configuration information pertaining to sensing resources used by the other UEs includes at least one priority associated with a sensing resource for at least one of the other UEs.

In some embodiments, lowering the sensing transmission power of the UE involves reducing the sensing transmission power to a value less than a most recent value of the sensing transmission power from prior to determining the sensing transmission power should be reduced.

In some embodiments, a value less than a most recent value of the sensing transmission power is: a value equal to an initial power: or a value that has been previously configured.

In some embodiments, the method further involves increasing a sensing transmission power, by the UE, by at least one of: exponentially ramping the sensing transmission power; or linearly ramping the sensing transmission power.

In some embodiments, increasing the sensing transmission power is performed by the UE: prior to receiving an indication for the UE to adjust UE sensing transmission power; or after the UE has adjusted UE sensing transmission power by reducing the UE sensing transmission power.

In some embodiments, the method further involves receiving an indication of a threshold indicating a maximum sensing transmission power for the UE when ramping up the sensing transmission power.

In some embodiments, the method further involves receiving, by the UE, priority configuration information for defining the priority of the of the UE.

In some embodiments, the priority of the resource of the UE is determined based on a sensing requirement report of the UE.

In some embodiments, detecting interference from the second UE involves detecting, by the UE, a sensing resource from the second UE that enables determining the priority of the sensing resource of the second UE based on the configuration information pertaining to sensing resources used by other UEs.

In some embodiments, transmitting, by the UE, a sensing transmission power reduction request to reduce the transmission power of the second UEs involves: transmitting, by the UE, the request to reduce the sensing transmission power to the second UE over SL to the second UE; or transmitting, by the UE, the request to reduce the sensing transmission power to a base station over UL so that the base station forwards the request to reduce the sensing transmission power to the second UE over downlink (DL).

In some embodiments, the method further involves receiving, by the UE, sensing configuration information pertaining to interference avoidance, the sensing configuration information pertaining to interference avoidance involving at least one of: sensing transmission timing offset information for offsetting timing of a sensing transmission; or sensing transmission signal interval information for changing an interval of a sensing transmission.

According to some aspects of the disclosure there is provided a device including a processor and a computer-readable storage media. The computer-readable storage media has stored thereon, computer executable instructions, that when executed by the processor, perform a method as described above or detailed below.

According to some aspects of the disclosure, there is provided a method involving: transmitting, by a base station, a first set of a plurality of power control parameters for determining transmission power of a UL communication transmission or SL communication transmission and a second set of a plurality of power control parameters for determining transmission power of a sensing transmission.

In some embodiments, the method further involves transmitting, by the base station, an explicit indication as to whether a UE is to use the first set of the plurality of power control parameters determining transmission power of the UL communication transmission or the SL communication transmission or the second set of the plurality of power control parameters for determining transmission power of a sensing transmission.

In some embodiments, the method further involves transmitting, by the base station, a first association between the first set of the plurality of power control parameters and a first reference signal resource and a second association between the second set of the plurality of power control parameters and a second reference signal resource.

In some embodiments, the method further involves transmitting, by the base station, a first association between the first set of the plurality of power control parameters and a first resource configuration parameter and a second association between the second set of the plurality of power control parameters and a second resource configuration parameter.

In some embodiments, the resource configuration parameter is one of a reference signal bandwidth, a number of reference signal ports, a number of reference signal symbols, or a number of physical channel symbols.

In some embodiments, transmission power of the UL communication transmission or the SL communication transmission is determined using the first set of the plurality of power control parameters; or transmission power of a sensing transmission is determined using the second set of the plurality of power control parameters.

In some embodiments, the UL communication transmission or SL communication transmission and the sensing transmission are a sounding reference signal (SRS).

In some embodiments, parameters in the first set of parameters are different than parameters in the second set of parameters.

In some embodiments, a parameter or multiple parameters in the second set are dedicated for sensing power control.

In some embodiments, the method is for use in interference avoidance of sensing transmissions involving: upon detecting interference involving two or more UE, transmitting, by a base station, an indication for at least one UE to adjust UE sensing transmission power, wherein the indication is an indication of an absolute sensing transmission power or an indication of a differential sensing transmission power.

In some embodiments, the indication is transmitted on a UE specific DCI, a group-specific DCI, a MAC-CE or an RRC message.

In some embodiments, the indication includes are least one of: an indication of whether the UE is configured to adjust power control for both of UL communication transmission or SL communication transmission and sensing transmission; or a TPC.

In some embodiments, the method further involves transmitting, by the base station, configuration information indicating whether the indication of whether the UE is configured to adjust power control for both of UL transmission and sensing transmission indicator is included in the indication, and if not included, the indication is for adjusting sensing transmission power.

In some embodiments, the method further involves transmitting, by the base station, configuration information pertaining to sensing transmission power for other UEs.

In some embodiments, the method further involves receiving, by the base station, a report involving interference information measured by at least one UE.

In some embodiments, the method is for use in interference avoidance of sensing transmissions involving: transmitting, by a base station, configuration information pertaining to sensing resources used by at least one UE, wherein the configuration information enables a first UE to determine a priority of a sensing resource of a second UE so when interference is detected between the first UE and the second UE, the first UE is configured to compare a priority of a sensing resource of the first UE with a priority of a sensing resource used by the second UEs.

In some embodiments, the configuration information pertaining to sensing resources used by the at least one UE involves a priority associated with a sensing resource for at least one of the other UEs.

In some embodiments, the method further involves transmitting, by the base station, threshold information for use by the first UE during interference mitigation, the threshold information being compared to a sensing transmit power of the first UE that has been exponentially ramped up.

In some embodiments, the method further involves transmitting, by the base station, priority configuration information for defining the priority of the of the first UE.

In some embodiments, the method further involves transmitting a sensing transmission power reduction request to reduce the transmission power of the second UE, wherein transmitting the sensing transmission power reduction request involves: receiving, by the base station over UL from the first UE, a request to reduce the sensing transmission power of the second UE; forwarding, by the base station, the request to reduce the sensing transmission power to the second UE over DL.

In some embodiments, the method further involves transmitting sensing configuration information pertaining to interference avoidance, the sensing configuration information pertaining to interference avoidance involving at least one of: sensing transmission timing offset information for offsetting timing of a sensing transmission; or sensing transmission signal interval information for changing an interval of a sensing transmission.

According to some aspects of the disclosure there is provided a device including a processor and a computer-readable storage media. The computer-readable storage media has stored thereon, computer executable instructions, that when executed by the processor, perform a method as described above or detailed below.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the present disclosure may occur.

FIG. 1B is another schematic diagram of a communication system in which embodiments of the present disclosure may occur.

FIG. 2 is a block diagram illustrating units or modules in a device in which embodiments of the present disclosure may occur.

FIG. 3 is a block diagram illustrating units or modules in a device in which embodiments of the present disclosure may occur.

FIG. 4 includes two examples of tabulated information for use in an adaptive transmit power control (TPC) method for sensing and UL transmission control according to an aspect of the present disclosure.

FIG. 5A illustrates an example of determining values to be used over increasing time as part of a method of power ramping using exponential power ramping for sensing transmission according to an aspect of the present disclosure.

FIG. 5B illustrates an example of determining values to be used over increasing time as part of a method of power ramping using both exponential and linear power ramping for sensing transmission according to an aspect of the present disclosure.

FIG. 6A is a schematic diagram illustrating a first example of adaptive controlled variable pulse power ramping with power back off for interference mitigation according to an aspect of the present disclosure.

FIG. 6B is a schematic diagram illustrating a second example of adaptive controlled variable pulse power ramping with power back off for interference mitigation according to an aspect of the present disclosure.

FIG. 7A is a schematic diagram illustrating an example of adaptive sensing timing offset for use in interference mitigation according to an aspect of the present disclosure.

FIG. 7B is a schematic diagram illustrating an example of adaptive sensing interval for use in interference mitigation according to an aspect of the present disclosure.

FIG. 8 illustrates an example of a signal flow diagram for signaling between a base station and UE in accordance with embodiments of the present disclosure.

FIG. 9 illustrates another example of a signal flow diagram for signaling between a base station and UE in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

According to some aspects of the present disclosure, there is provided an adaptive sensing method that enables separate power control parameter configuration for uplink (UL) communication transmission or sidelink (SL) communication transmission and sensing transmission. In some embodiments, a parameter or multiple parameters are dedicated for sensing power control. When a signal or a channel is used for both communication and sensing, two sets of parameters may be configured, a first set of parameters for UL or SL communication and a second set of parameters for sensing. In some embodiments, one or both of the first and second sets of parameters for power control may be explicitly indicated to the UE. In some embodiments, one or both of the first and second sets of parameters for power control may be implicitly provided to the UE so that the UE may be able to determine power control information from the provided information.

According to some aspects of the present disclosure, there is provided a distributed power control method that involves slow power ramping of a transmitted signal used for sensing. The slow power ramping may include exponential power ramping or linear power ramping, or both types of power ramping. The distributed power control method may also include interference avoidance. Interference avoidance may include interference measurement and interference mitigation. In some embodiments, the UE may be notified of sensing resources (e.g. time and frequency to be used for sensing signals, sequence resources) of other UEs. In some embodiments, the UE may be notified of an associated sensing priority of one or more other UEs, or more generally an overall priority of one or more other UEs. When measured interference from one or more other UEs exceeds a threshold, when the UE has a higher priority than the one or more other UEs, the UE requests the one or more other UEs to reduce interference. This may involve having the one or more other UEs reduce power or change sensing resources. When measurement interference from one or more other UEs exceeds a threshold, when the UE has a lower priority than other UEs, the UE reduces its power or changing sensing resources, or both, to avoid interference with the one or more other UEs. Changing the sensing resources may involve changing the UE sensing pattern that
includes features such as sensing timing offset or sensing signal interval, or both.

According to some aspects of the present disclosure, there is provided a centralized power control method that involves, a centralized network side device, such as a base station, sending a signaling to adapt UE power to mitigate interference between UEs when interference is detected.

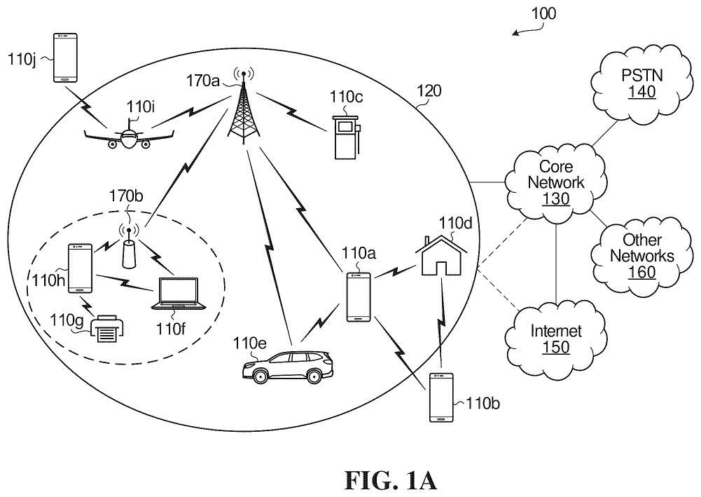

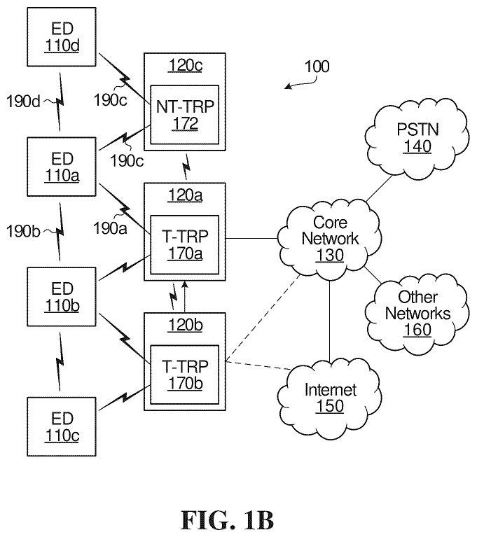

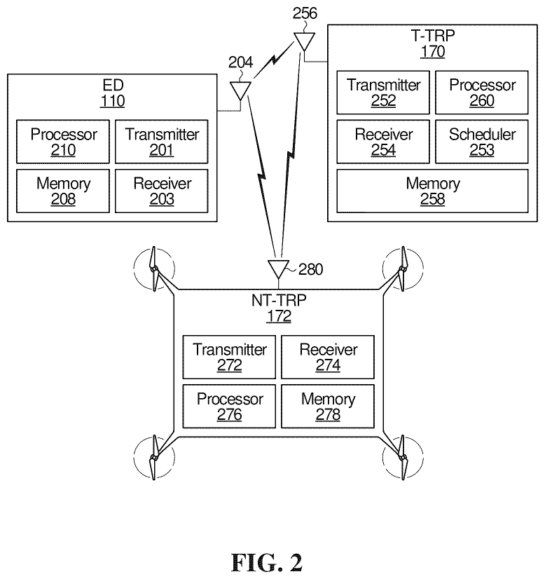

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b,172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high-altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off(i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A or 1B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 2. FIG. 2 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

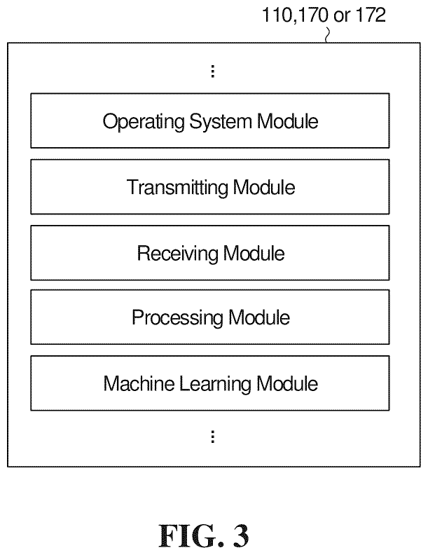

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. A new protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g. uplink control information (UCI) sent in a PUCCH or PUSCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH or PUSCH.

According to some aspects of the present disclosure there is provided an adaptive sensing method that enables separate power control parameter configuration for UL communication transmission (or SL communication transmission) and for sensing transmission. An example of an existing UL power control scheme may be found in Section 7 of 3GPP TS 38.213 v17.2.0. An example of an existing sidelink power control scheme may be found in Section 16.2 in 3GPP TS 38.213 v17.2.0.

In some embodiments, when a signal or a channel is used for both UL or SL transmission communication and sensing, two sets of parameters may be configured for the UE, a first set of parameters for UL or SL communication and a second set of parameters for sensing. A network side device, such as a base station, may provide configuration information to configure separate power control parameters for UL communication (and/or SL communication) transmission and for sensing transmission. The UE may then determine the transmission power for UL or SL communication transmission and for sensing transmission according to the provided configuration information from the network side device.

In some embodiments, one or multiple parameters are dedicated for sensing power control. An example of a parameter dedicated for sensing power control is a maximum sensing power used by the UE, which may be indicated by P_{MAX,sensing}. This maximum sensing power is typically less than a maximum transmit power capability of the UE, which may be indicated by P_{CMAX}.

The following is an example of how sensing power, P_{Sensing}(i), where i is an integer representing an index of time occasion (e.g. time slot, or symbol) for which the sensing power is being determined, may be determined at the UE based on configuration information provided to the UE by a network side device. The UE may determine P_{Sensing}(i) for a sensing signal or sensing channel transmission in transmission occasion i according to the example formula below:

$${P}_{S e n s i n g} ( i ) = min ( {P}_{C M A X} , {P}_{M A X , s e n s i n g} , {P}_{O , S} + 10 {log}_{10} ( {2}^{μ} \cdot {M}_{R B}^{S e n s i n g} ( i ) ) + {α}_{S} \cdot {PL}_{S} ) Bm ] ,$$

where P_{CMAX} is a maximum output capability power of the UE, P_{MAX,sensing} is a maximum sensing power configured by the network side device, P_{o,s} is a target sensing receiving power configured by the network side device, μ is a subcarrier index used by a sensing signal or a sensing channel, M_{RB}^{Sensing}(i) is a resource block (RB) number used by the sensing signal or the sensing channel, PL_{S} is a reference path loss, and as is a coefficient for a reference path. In some embodiments, P_{MAX,sensing}, P_{O,S}, PL_{S}, and as are dedicated parameters for sensing power control. PL_{S} and as may be configured by the network side device. Example values of μ for several different sub-carrier spacing (SCS) include, but are not limited to, μ=0 for 15 kHz SCS, μ=1 for 30 kHz SCS, μ=n for 15*2″kHz SCS).

When a signal, or a channel, may be used as both UL (or SL) communication transmission signal, or UL (or SL) communication transmission channel, and sensing transmission signal, or sensing transmission channel, the network side device may configure two sets of power control parameters, wherein one set of power control parameters is for the UL, or SL, communication transmission and the other set of power control parameters is for the sensing transmission. One example of a signal used as both the UL (or SL) communication transmission signal and for the sensing transmission signal is a sounding reference signal (SRS). One example of a channel used as both the UL (or SL) communication transmission channel and for the sensing transmission channel is a physical uplink shared channel (PUSCH).

While calculation of sensing power is described above with reference to the equation for P_{Sensing}(i), UL communication power or SL communication power may be determined in a similar fashion with similar types of parameters that pertain to UL communication or SL communication.

In some embodiments, the UE determines transmission power according to a function, f(a,b,c,d), where a, b, c, and d are representative of parameters configured by the network side device. In a particular example in which a first set of parameters includes {a1,b1,c1,d1} for UL (or SL) communication transmission and a second set of parameters {a2,b2,c2,d2} for sensing transmission, at least one parameter in the two sets of parameters is different. It should be understood that while the sets of parameters indicated above include 4 parameters (a,b,c,d), there may be more or less than four parameters in the set for determining the transmission power.

With regard to using SRS as a signal, when a UE transmits SRS on an active UL bandwidth part (BWP) b of carrier f of serving cell c using SRS power control adjustment state with index l, the UE may determine the SRS transmission power P_{SRS,b,f,c} (i, qₛ, l) in SRS transmission occasion i as

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ]$$

where P_{CMAX,f,c}(i) is the UE configured maximum output power for carrier f of serving cell c in SRS transmission occasion i, P_{O_SRS,b,f,c}(qₛ) is configured by the base station for active UL BWP b of carrier f of serving cell c and SRS resource set qₛ, M_{SRS,b,f,c}(i) is a SRS bandwidth expressed in number of resource blocks for SRS transmission occasion i on active UL BWP b of carrier f of serving cell c, μ is a SCS configuration, a_{SRS,b,f,c}(_{qs}) is provided by an a value for active UL BWP b of carrier f of serving cell c and SRS resource set qₛ, PL_{b,f,c}(q_{d}) is a downlink pathloss estimate in dB calculated by the UE using RS resource index q_{d}, and h_{b,f,c}(i, l) is for the SRS power control adjustment state for active UL BWP b of carrier f of serving cell c and SRS transmission occasion i.

Continuing with the example of using SRS as a signal, the network side device may configure two sets of power control parameters for SRS, the first set of parameters for UL channel sounding and the second set of parameters for sensing, each set includes one or multiple of the following parameters P_{O_SRS,b,f,c}(qₛ), M_{SRS,b,f,c}(i), a_{SRS,b,f,c}(qₛ), PL_{b,f,c} (q_{d}), h_{b,f,c}(i, l). When SRS is used for UL channel sounding, the UE shall use the first set of parameters for power control and when SRS is used for mono-static or bi-static sensing, the UE shall use the second set of parameters for power control.

In some embodiments, the network side device provides the configuration information to the UE explicitly. The configuration information may be provided to the UE via one or more of DCI, MAC-CE or RRC. In some embodiments, subsequent to the UE being provided with the first and second sets of parameters, the UE is notified by the network side device that the first set of parameters are for use with UL or SL transmission and the second set of parameters are for use with sensing transmission, or vice versa.

In some embodiments, subsequent to the UE being provided with the first and second sets of parameters, the network side device provides configuration information to the UE and the UE may implicitly determine which set of parameters to use for UL communication (or SL communication) or for sensing.

The following examples show how selecting an appropriate set of parameters may be based on reference signal resources or resource configuration parameters provided by the network side device.

In some embodiments, each set of parameters may be associated with a reference signal (RS) resource being defined by time, frequency, spatial resources, where the association is configured by the network side device or the association is pre-defined. Based on the selected resource and the association, the UE may then know the appropriate set of parameters to use for power control.

In some embodiments, each set of parameters may be associated with a specific resource configuration parameter, where the association is configured by the network side device or is pre-defined for the UE. Therefore, if the UE is configured for a particular resource configuration, based on the association, the UE selects an appropriate set of parameters to use for power control.

Several examples of different types of resource configuration parameter associations are described below.

In a first example, the sets of parameters are associated with RS bandwidth (BW) or channel BW that is used by the UE. If the RS BW or channel BW is less than or equal to a threshold, the UE selects UL transmission-specific parameters. In some embodiments, if the RS BW or channel BW is greater than a threshold, the UE selects sensing-specific parameters by default. In some embodiments, if the RS BW or channel BW is greater than a threshold, the UE is configured to select parameters for UL transmission or sensing-specific parameters by the network side device via RRC. The threshold may be configured by the network side device or predefined.

In a second example, the sets of parameters are associated with a number of RS ports. If the number of RS ports is greater than a threshold, the UE selects UL transmission-specific parameters. In some embodiments, if the number of ports is less than or equal to a threshold, the UE selects sensing-specific parameters by default. In some embodiments, if the number of ports is less than or equal to a threshold, the UE is configured to select parameters for UL transmission or sensing-specific parameters by the network side device via RRC. The threshold may be configured by the network side device or preconfigured.

In a third example, the sets of parameters are associated with a number of RS symbols or channel symbols. If the number of RS symbols or channel symbols is greater than a threshold the UE selects UL transmission-specific parameters UL Tx-specific parameters. In some embodiments, if the number of RS symbols or channel symbols is less than or equal to a threshold, the UE selects sensing-specific parameters by default. In some embodiments, if the number of RS symbols or channel symbols is less than or equal to a threshold, the UE is configured to select parameters for UL transmission or sensing-specific parameters by the network side device via RRC. The threshold may be configured by the network side device or preconfigured.

FIG. 9 illustrates an example of a signal flow diagram 900 for providing an adaptive sensing method that enables separate power control parameter configuration for UL communication transmission (or SL communication transmission) and for sensing transmission for use by a UE that has both communication and sensing capability. FIG. 9 shows signaling between a base station 905 and a UE 907.

At step 910, a first set of a plurality of power control parameters for determining transmission power of a UL) communication transmission or a SL communication transmission and a second set of a plurality of power control parameters for determining transmission power of a sensing transmission are transmitted by the base station 905 to the UE 907.

Step 915 is an optional step that includes the base station 905 sending an indication to select the first set of the plurality of power control parameters or the second set of the plurality of power control parameters. While this may be performed in some embodiments, in other embodiments, the UE 907 selects the appropriate set of parameters for the appropriate action to be performed by the UE 907

At step 920, the UE 907 determines at least one of transmission power for an UL transmission, or SL transmission, based on the first set of the plurality of power control parameters or transmission power for a sensing transmission based on the second set of the plurality of power control parameters.

In some embodiments, for example if the UE does not receive the indication sent in optional step 915, the UE determines whether to use the first set of the plurality of power control parameters or the second set of the plurality of power control parameters based on the first and second sets of plurality of power control parameters each being associated with a reference signal resource and when a given reference signal resource is selected, the associated first or second set of the plurality of power control parameters is selected.

In some embodiments, for example if the UE does not receive the indication sent in optional step 915, the UE determines whether to use the first set of the plurality of power control parameters or the second set of the plurality of power control parameters based on the first and second sets of plurality of power control parameters each being associated with a resource configuration parameter and when a given resource configuration parameter is selected, the associated first or second set of the plurality of power control parameters is selected. The resource configuration parameter may be one of a reference signal bandwidth, a number of reference signal ports, a number of reference signal symbols, or a number of physical channel symbols.

At step 930, the UE determines a transmission power of an uplink (UL) communication transmission or a SL communication transmission using the first set of the plurality of power control parameters or determines the transmission power of a sensing transmission using the using the second set of the plurality of power control parameters.

In some embodiments, the UL communication transmission or a SL communication transmission and the sensing transmission is a sounding reference signal (SRS).

In some embodiments, parameters in the first set of parameters are different than parameters in the second set of parameters.

In some embodiments, a parameter or multiple parameters in the second set are dedicated for sensing power control.

Providing the use of separate power control parameters for UL or SL communication transmission and for sensing may enable flexible configuration for sensing power control.

According to some aspects of the present disclosure, there is provided a centralized power control method that involves a network side device sending a signaling to one or more UEs to adapt UE sensing power to mitigate interference between UEs when interference is detected.

In some embodiments, the network side device notifies a UE to adapt its sensing transmission power. In some embodiments, the network side device sends notification to the UE when the network side device observes interference between UEs. In some embodiments, the network side device may observe interference between UEs based on receiving UE reports from one or more UEs that provide measurement of other UE resources. In some embodiments, the network side device may observe interference between UEs based on performing measurements of UE resources and determine there is possible interference based on the measurements. In some embodiments, for example in a bi-static sensing scenario, the network side device receives a sensing signal from two different UEs and measures interference between the sensing signals.

In some embodiments, after the network side device determines there is interference between UEs, the network side device indicates a value of transmission power to one or more UEs that the UEs should use to avoid potential interference. For example, the network side device indicates an updated value for a power control parameter, or the network side device indicates a transmission power for the UE. The indication of the value of the transmission power may be carried on downlink control information (DCI), media access control-control element (MAC-CE), or radio resource element (RRC).

In some embodiments, after the network side device determines there is interference between UEs, the network side device indicates to one or more UEs to increase or reduce the UE sensing power. The indication of the value of the transmission power may be carried on UE-specific DCI, group-specific DCI, MAC-CE, or RRC.

The following provides an example of how an indication of transmission power may be transmitted via of a DCI, where the DCI is for the transmission of Transmit Power Control (TPC) commands for sensing. In some embodiments, the TPC with a cyclic redundancy check (CRC) may be scrambled using a radio network temporary identifier (RNTI), for example a TPC sensing RNTI (TPC-SENSING-RNTI). The indication of transmission power may be transmitted by the network side device for each UE on a block by block basis, i.e., block number 1, block number 2, . . . , block number N. In a particular example, a parameter denoted as tpc-SENSING that is transmitted by higher layers may indicate the index of the block number for the UE.

For each block, the indication of transmission power may include one or more fields to provide the UE information. Examples of two different fields that be included in the indication are a UL transmission and sensing indicator field and a TPC command field. The UL transmission and sensing indicator field may a single bit. For example, when this field is ‘o’, the power control indication is for UL transmission and when the field is ‘1’ the power control indication is for sensing.

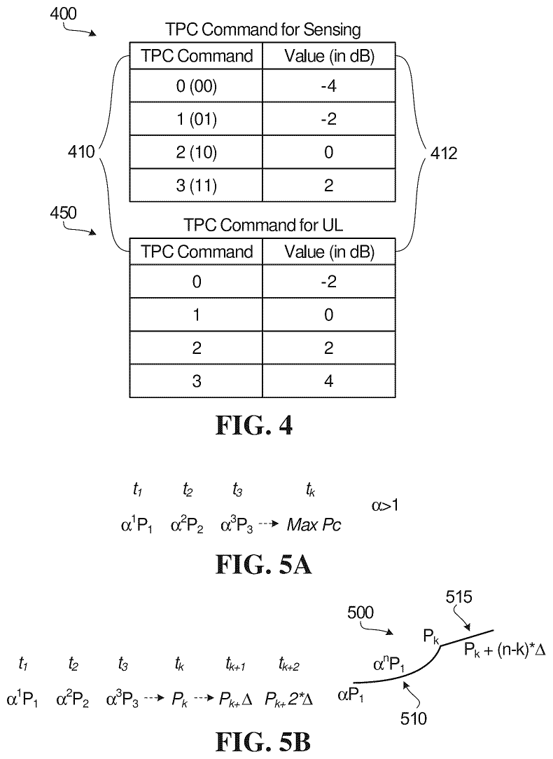

The TPC command field includes one or more bits that act as an index associated with a particular power value. The values in the TPC command field may be used to increase or decrease UE transmission power. FIG. 4 shows an example of two groups of TPC commands, a first group 400 for sensing transmission and a second group 450 for UL transmission. In FIG. 4, the TPC command field is indicated to be values from 0 to 3. Four values of this type may be represented by two two bits (00, 01, 10, 11). Each group 400, 450 of bits for the TPC command is shown in a respective table in FIG. 4 in which a first column 410 of the table is a TPC Command value acting as the index associated with a power value and a second column 412 is the associated power value in decibels (dB). When the UE is notified of a TPC Command index, the UE increases or decreases the sensing transmission or UL or SL transmission power according to the associated power value. The updated power is expressed as Pupdate=Pcurrent+4, where 4 is the value from the second column selected based on the indicated TPC Command index. While FIG. 4 illustrates the example of the TPC Command index being two bits, it is to be understood that this is merely an example and the TPC Command index may have more or less than two bits.

In some embodiments, a set of TPC command values for sensing and UL communication (or SL communication) transmission may include similar values for sensing and for UL communication (or SL communication) transmission. In some embodiments, the set of TPC command values for sensing and UL transmission may include one or more values for sensing and UL communication (or SL communication) transmission that are different in the respective sets of TPC command values. If the UL communication (or SL communication) transmission and sensing indicator field indicates TPC command is for UL communication (or SL communication) transmission, the UE determines the TPC value according to the set of TPC command values for UL communication (or SL communication) transmission. If the UL transmission and sensing indicator field indicates TPC command is for sensing, the UE determines the TPC value according to the set of TPC command values for sensing.

In some embodiments, there may not be a UL communication (or SL communication) transmission and sensing indicator field if the UE is not configured to indicate power control is for either UL communication (or SL communication) or sensing.

In some embodiments, the network side device may notify one or more UEs of sensing resources (e.g. time/frequency, sequence resources) used by other UEs. This may enable UEs to be aware of sensing resources that other UEs are using and thereby allow UEs to know which other UEs are interfering with the UE based on measurements made on those resources.

The UE may measure resources that are identified by the network side device. In some embodiments, to assist power control by the network side device, the UE may report measurement information to the network side device, such as interference measured by the UE. This may enable the network side device to notify particular UEs to increase or decrease the power based on the network side device knowledge of measurements from multiple UEs and other knowledge such as, for example, the priority of the UEs.

Centralized UE power control that includes the base station forwarding power control information to UEs may enable interference coordination among multiple UEs that are performing sensing.

According to some aspects of the present disclosure, there is provided a distributed power control method that involves UEs coordinating power control for the UEs when interference is detected amongst the UEs.

Some UEs may have different sensing service requirements than that of other UEs. Sensing service requirements may include parameters such as, but not limited to, sensing latency, accuracy, resolution for range, angle, or velocity, detection probability, and false alarm probabilities. Sensing service requirements may affect the sensing priority or more generally the priority of the UE.

In some embodiments, a UE is configured with sensing priority by a base station, or more generally an overall priority. In some embodiments, a first UE may be notified of a priority for a second UE by a sensing requirement report sent from the second UE to the first UE.

In some embodiments, a UE may measure interference from one or more other UEs. When interference has been detected, and when the interference is determined to exceed a threshold, the UE may determine whether the UE has a higher or lower priority than the one or more other UEs that are determined to be interfering with the UE. The threshold may be configured for the UE or may be predefined. For example, the network side device may provide the threshold to the UE as part of configuration information, or the UE may be pre-configured with a threshold value.

When a first UE determines that the first UE has a higher priority than a second UE with which there is interference, the first UE may be considered a Type 1 UE. When the first UE is considered a Type 1 UE and detects the measured interference exceeds the threshold, the first UE sends a request to the second UE with a lower priority to reduce the transmission power or change sensing resources of the second UE with a lower priority so as to reduce interference.

When the first UE determines it has a lower priority than the second UE with which there is interference, the first UE is considered a Type 2 UE. When the first UE is considered a Type 2 UE and detects the interference exceeds the threshold, the first UE may autonomously reduce power or change a sensing pattern, or both, to avoid interference with the second UE.

In some embodiments, the first UE may determine it is a Type 2 UE by receiving a notification from the second UE that the first UE needs to reduce the transmission power or change sensing resources. In some embodiments, the first UE may determine it is a Type 2 UE by receiving priority information from the second UE and upon comparing the priority of the first UE priority with the priority information from the second UE, determines the first UE has a lower priority than the second UE.

### Interference Measurement by a UE:

In some embodiments, the UE is notified of sensing resources (e.g. time/frequency, sequence resources) of one or more other UEs. In addition, the associated priority of a sensing resource may also be indicated. Different sensing sequences may be associated with different sensing priority, so a UE with a particular priority may be assigned a sensing sequence appropriate for the UE priority. As a result, when a UE is notified of sensing resources of other UEs, and the UE knows particular priorities are associated with particular sensing resources, when the UE detects a particular sensing resource the UE is able to determine the priority of the other UE based on the detected sensing sequence. In some embodiments, when a UE is notified of sensing resources and priorities of other UEs, when the UE detects a particular sensing resource, the UE may be able to determine the identity of the other UE based on the detected the sensing sequence As a result of an association between priority and sensing sequence, upon detecting the sensing resource of one or more other UEs as part of an interference measurement, the UE may be able to determine the priority level of the one or more other UEs. In some embodiments, the overall priority of the one or more other UEs may be provided to the UE and the overall priority of the one or more other UEs may be associated with sensing resources of the one or more other UEs.

In some embodiments, by comparing the priority of the one or more other UEs and the priority of the UE, the UE may determine whether the UE is a Type 1 UE or a Type 2 UE.

The following describes scenarios occurring between two UEs, a first UE and a second UE, that are coordinating interference mitigation during sensing. When the first UE is a Type 1 UE, the first UE may send an interference reduction request to the second UE, which has a lower priority. The interference reduction request may include the priority level of the UE sending the request.

In some embodiments, the interference reduction request may be carried on a SL channel directly to the second UE using broadcast, groupcast, or unicast. In some embodiments, the request may be sent to the second UE via a Uu link. The interference reduction request is sent on an UL channel to the network side device, such as a base station, and the network side device forwards the interference reduction request to the second UE.

When the first UE is a Type 2 UE, the first UE may reduce the transmission power of the first UE or change at least one sensing resource. The transmission power and the at least one sensing resource may be changed according to a predefined rule or a rule that has configured by a network side device.

The following example describes a method for a UE performing sensing (either mono-static or bi-static sensing) in which the UE determines transmit sensing power while using an adaptive controlled variable pulse methodology.

### Slow Power Ramping

As part of an nth sensing transmission, where n is an integer value, the UE determines transmit power according to a relationship indicated in equation (1) below:

$${P}_{n} = min ( {α}^{n - 1} * {P}_{1} , {P}_{Max , C} ) \qquad ( 1 )$$

where a>1, P1 is an initial power, and P_{Max,C} is a UE maximum transmit power. Parameters a and P1 may be configured by the base station. In some embodiments, P_{Max,C} is the maximum transmit power the UE is capable of transmitting that is predefined for the UE. In some embodiments, P_{Max,C} is the maximum transmit power as configured for the UE by the network side device.

FIG. 5A illustrates a series of transmit powers for a UE based on equation (1) for sensing transmission times t₁, t₂, t₃, and tₖ, where k is a time at which the UE reaches the maximum transmit power threshold P_{Max,C}. The power ramping is an exponential increase over the time interval from t₁, to tₖ because a>1.

In an alternative example, as part of an nth sensing transmission, where n is an integer value, the UE determines transmit power according to a relationship indicated in equation (2) below:

$${P}_{n} = min ( {α}^{n - 1} * {P}_{1} , Pth ) \qquad ( 2 )$$

where a>1, P1 is an initial power, and Pₜₕ is a threshold transmit power. The threshold transmit power Pₜₕ may be configured by the network side device.

In some embodiments, the UE may use exponential power ramping up to the threshold and then after the exponential power ramping, the UE may perform linear power ramping. For example, when the UE transmit power capable by the UE is larger than a maximum power threshold for exponential ramping that is configured by the network device, the UE may continue to increase transmit power linearly. On an nth sensing transmission after tₖ transmission, the UE determines transmit power according to equation (2) indicated below:

$${P}_{n} = min ( {P}_{K} + ( n - K ) * Δ , {P}_{Max , C} ) \qquad ( 3 )$$

where Δ is the increasing power step, K is a time occasion, i.e. Kₜₕ transmission, at which time the UE transmit power is larger than the threshold P_{ThK}. The parameter Δ may be configurable by the network side device.

FIG. 5B illustrates a series of transmit powers for a UE based on equations (2) and (3) for times t₁, t₂, t₃, tₖ, tₖ+1, and tₖ+2, where k is a time at which the UE reaches a maximum power threshold for exponential ramping PThK. The maximum power threshold for exponential ramping P_{ThK} may be configured by the network side device. FIG. 5B also shows a graphical plot 500 with the exponential range 510 up to a point in time tx and the linear range 515 thereafter.

### Interference Avoidance

As described above, when the UE is a Type 2 UE and the UE needs to reduce the transmit power, the UE may reduce the UE transmit power according to a predefined or a preconfigured rule. Two different methods for reducing the transmit power will be described below for a first UE that is the Type 2 UE and a second UE that is a Type 1 UE.

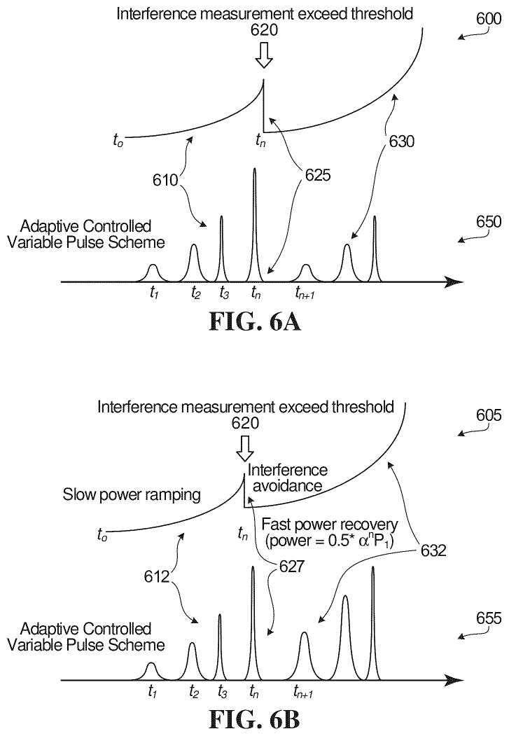

In a first method, when the first UE receives an interference reduction request from the second UE or when the first UE measures interference and finds the priority of the second UE is higher, the first UE performs power reduction. In the first method, the first UE reduces the power to an initial transmit power (e.g. a° P₁). FIG. 6A illustrates an example of a continuous curve 600 showing a first power ramping section 610 and a second power ramping section 630 and a power reduction 625. FIG. 6A also illustrates an adaptive controlled variable pulse curve 650 showing the same first and second power ramping sections 610 and 630 and the power reduction 625 with pulses at discrete times that are limited in amplitude by the continuous curve 600. Both curves 600 and 650 of FIG. 6A illustrate the transmission power ramping between tₒ and tₙ. At tₙ, an interference measurement is determined to exceed a threshold 620. The first UE then reduces 625 the power to the initial transmit power.

In a second method, the first UE reduces transmission power to an amount that is N times the power value when the interference measurement was detected to exceed the threshold. The value of N is less than 1, for example N=0.5. The value of N may be configured by the network side device or may be pre-defined. FIG. 6B illustrates an example of a continuous curve 605 showing a first power ramping section 612, a second power ramping section 632 and power reduction 627. FIG. 6B also illustrates an adaptive controlled variable pulse curve 655 showing the same first and second power ramping sections 612 and 632 and power reduction 627 with pulses at discrete times that are limited in amplitude by the continuous curve 605. Both curves 605 and 655 of FIG. 6B illustrate the transmission power ramping between tₒ and tₙ. At tₙ, an interference measurement is determined to exceed a threshold 620. The power is then reduced 627 to a portion of the power when the interference measurement was detected to exceed the threshold 620. Not reducing the power all the way to the initial power as in the first method enables a faster power recovery for the first UE.

For both the first and second methods described above, after the power of the first UE is reduced according to an appropriate rule (i.e. initial power or a fraction of the power when the interference measurement was detected to exceed the threshold), the first UE may return to ramping the transmit power according to an appropriate power ramping method as described above.

When determining the power via the ramping methods described above and with reference to FIGS. 6A and 6B, the UE may use separate sets of parameters for determining the power for sensing and for UL or SL communication as described above.

In addition to reducing power to avoid interference or as an alternative to reducing power to avoid interference, one or more sensing configuration parameters may be adapted at one or more UEs to mitigate interference. Examples of sensing configuration parameters that may be adapted include, but are not limited to, sensing timing offset and sensing signal interval.

For a sensing transmission that is periodic in nature, a UE may be configured to transmit a sensing signal at time occasions based on a relationship such as nₒ+periodicity*n, where nₒ is an initial transmit time, n is a transmission number and periodicity is a fixed period between transmissions. Transmission occasions may occur on a slot by slot basis or on a symbol by symbol basis. In some embodiments, a sensing timing offset K may be added to the timing relationship, such that the UE may send a sensing signal on a time occasion based on a relationship nₒ+K+periodicity*n.

In some embodiments, a sensing signal interval may be changed by an amount M, where M can be a value greater than 0, and more commonly greater than 1. When the interval is configured as M times the periodicity, the UE will transmit the sensing signal on a time occasion based on the relationship nₒ+periodicity*M*n.

In some embodiments, the timing offset or timing interval, or both, is configured by the network side device. In some embodiments, the network side device may configure a set of timing offsets or a set of timing intervals, or both, for the UE.

In some embodiments, the UE may be configured to adapt a sensing timing offset or adapt a sensing interval, or both. If the UE desires to reduce interference with respect to one or more other UEs, the UE may choose an appropriate offset or interval from a set of timing offsets provided to the UE.

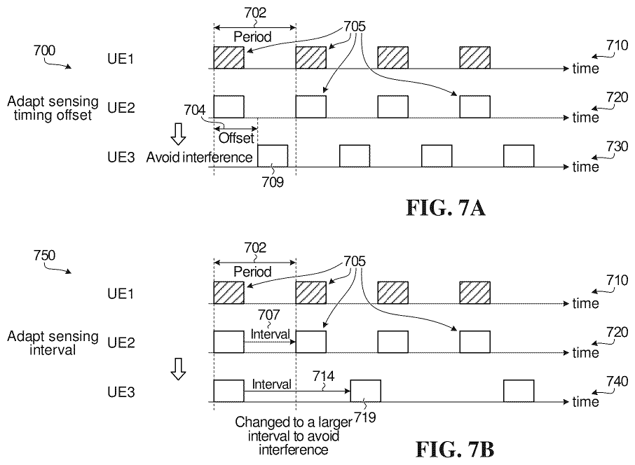

FIG. 7A illustrates an example 700 of two UEs, UE1 and UE2 that are transmitting sensing signals 705 with a period 702 between sensing transmissions. The transmissions are shown on time sequences that occur over increasing time on a horizontal axis. UE1 and UE2 are shown transmitting sensing signals 705 at the same time in a first time sequence 710 and a second time sequence 720. In this example, it is assumed that UE1 is a Type 1 UE and UE2 is a Type 2 UE. Therefore, when UE1 measures interference from UE2, UE1 notifies UE2 to undertake interference mitigation. Upon such notification, UE2 selects a sensing timing offset 704 to offset the time at which UE2 transmits a sensing signal 709 with respect to the transmission by UE1, as shown in a third time sequence 730. Alternatively, UE2 may detect interference and autonomously take action to undertake interference mitigation. Because the sensing signal transmissions for UE1 and UE2 in time sequences 710 and 730 occur at different times, there is less opportunity for interference.

FIG. 7B illustrates another example 750 of two UEs, UE1 and UE2 that are transmitting sensing signals 705 with a period 702 between sensing transmissions. The transmissions are shown on time sequences that occur over increasing time on a horizontal axis. UE1 and UE2 are shown transmitting sensing signals 705 at the same time in a first time sequence 710 and a second time sequence 720. In the second time sequence 720, there is a first time interval 707 indicated between the end of the first sensing signal and the beginning of the second sensing signal. In this example, it is assumed that UE1 is a Type 1 UE and UE2 is a Type 2 UE. Therefore, when UE1 measures interference from UE2, UE1 notifies UE2 to undertake interference mitigation. Upon such notification, UE2 selects a second sensing interval 714 to change the period at which UE2 transmits a sensing signal 719 with respect to the transmission by UE1, as shown in a third time sequence 740. Alternatively, UE2 may detect interference and autonomously take action to undertake interference mitigation. Because the sensing signal transmissions for UE1 and UE2 in time sequences 710 and 740 occur at different times, there is less opportunity for interference.

Distributed UE sensing power control that includes multiple UEs coordinating power control information between UEs may enable improving spectrum efficiency among multiple UEs that are performing sensing.

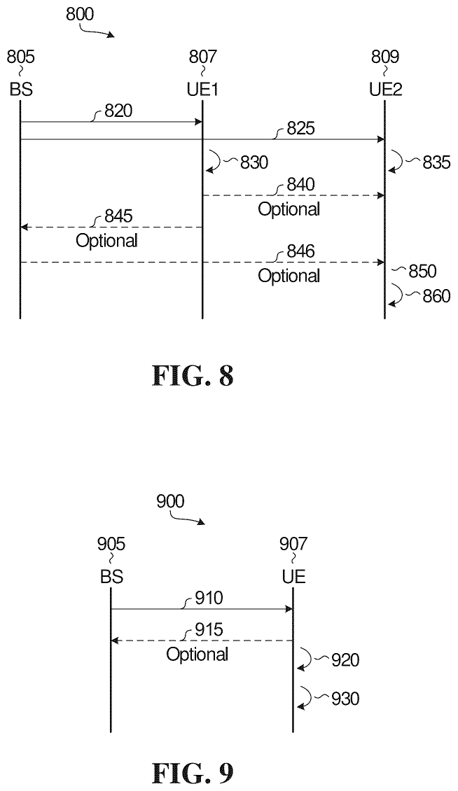

FIG. 8 illustrates an example of a signal flow diagram for power ramping and interference mitigation for a distributed UE sensing power control method, in accordance with embodiments of the present disclosure. FIG. 8 shows signaling between a base station 805, a first UE (UE1 807) and a second (UE2 809).

At step 820, the base station 805 transmits one or more signals to convey configuration information to UE1 807. At step 825, the base station 805 transmits one or more signals to convey configuration information to UE2 809. The configuration information sent by the base station includes one or more of information related to the sensing signals such as time and frequency resource information of the sensing signal, sensing interval, sensing time offset, interference threshold information, configuration information related to power ramping and power reduction, priority information for UE1 807 and UE2 809, or an association between a sensing resource and priority.

At step 830, UE1 807 performs power ramping of the sensing signaling and may perform interference measurement of signals from other UEs, such as UE2 809. At step 835, UE2 809 performs power ramping of the sensing signaling and may perform interference measurement of signals from other UEs, such as UE1 807.

In the case of FIG. 8, UE1 807 is determined to be a Type 1 UE and UE2 809 is determined to be a Type 2 UE. There are at least two possible ways for UE1 807 to notify UE2 809 that it should reduce power to mitigate interference between UE1 807 and UE2 809. At step 840, s first option is for UE1 807 to transmit the notification to reduce power directly to UE2 809. At step 845 and 846, a second option is for UE1 807 to transmit the notification to reduce power to the base station 805 and the base station 805 to transmit the notification to reduce power to UE2 809.

At step 850, UE2 809 receives the notification sent in either step 840 or step 846, and then takes steps to reduce the transmit power as shown in interference avoidance 625 or 627 in FIG. 6A or 6B, or change the sensing timing offset or sensing interval as illustrated in FIG. 7A or 7B, or both reducing power and changing the sensing timing offset or sensing interval.

In another embodiment, UE2 809 may determine there is interference between and UE1 807 and UE2 809 and because UE2 809 is a Type 2 UE. UE2 809 may autonomously reduce its power to mitigate interference.

At step 860, UE2 809 once again performs power ramping of the sensing signaling and may perform interference measurement of signals from other UEs such as UE1 807.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving, by a user equipment (UE), a first set of power control parameters for determining first transmission power of an uplink (UL) communication transmission or a sidelink (SL) communication transmission and a second set of power control parameters for determining second transmission power of a sensing transmission; and
determining, by the UE, at least one of:
the first transmission power for the UL communication transmission or the SL communication transmission based on the first set of power control parameters, or
the second transmission power for the sensing transmission based on the second set of power control parameters.

2. The method of claim 1, wherein the UE determines whether to use the first set of power control parameters or the second set of power control parameters based on receiving an indication to select the first set or the second set.

3. The method of claim 1, further comprising determining:
the first transmission power of the UL communication transmission or the SL communication transmission using the first set of power control parameters; or
the second transmission power of the sensing transmission using the using the second set of power control parameters.

4. The method of claim 1, wherein a parameter or multiple parameters in the second set are dedicated for sensing power control.

5. The method of claim 1, the method for use in interference avoidance of sensing transmissions comprising:
receiving, by the UE, an indication for the UE to adjust UE sensing transmission power, wherein the indication indicates an absolute sensing transmission power or a differential sensing transmission power; and
adjusting, by the UE, the UE sensing transmission power based on the indication.

6. The method of claim 5, wherein the indication is received on a UE specific downlink control information (DCI), a group-specific DCI, a media access control-control element (MAC-CE), or a radio resource control (RRC) message.

7. The method of claim 6, further comprising increasing the UE sensing transmission power, by the UE, by at least one of:
exponentially ramping the UE sensing transmission power; or
linearly ramping the UE sensing transmission power.

8. The method of claim 1, the method for use in interference avoidance of sensing transmissions comprising:
receiving, by the UE, configuration information pertaining to sensing resources used by other UEs;
when interference is detected from a second UE of the other UEs, comparing a first priority of the UE with a second priority of the second UE;
based on the comparing:
when the first priority of the UE is higher than the second priority of the second UE, transmitting a sensing transmission power reduction request to reduce transmission power of the second UE; or
when the first priority of the UE is lower than the second priority of the second UE, lower the UE sensing transmission power of the UE.

9. The method of claim 8, wherein the configuration information pertaining to the sensing resources used by the other UEs indicates at least one priority associated with a sensing resource for at least one of the other UEs.

10. An apparatus comprising:
one or more processors; and
a computer-readable storage media, having stored thereon, computer executable instructions, that when executed by the one or more processors cause the apparatus to:
receive a first set of power control parameters for determining first transmission power of an uplink (UL) communication transmission or a sidelink (SL) communication transmission and a second set of power control parameters for determining second transmission power of a sensing transmission; and
determine at least one of:
the first transmission power for the UL communication transmission or the SL communication transmission based on the first set of power control parameters; or
the second transmission power for the sensing transmission based on the second set of power control parameters.

11. A method comprising:
transmitting, by a base station, a first set of power control parameters for determining first transmission power of an uplink (UL) communication transmission or a sidelink (SL) communication transmission and a second set of power control parameters for determining second transmission power of a sensing transmission.

12. The method of claim 11 further comprising:
transmitting, by the base station, an explicit indication as to whether a user equipment (UE) is to use the first set of power control parameters for determining the first transmission power of the UL communication transmission or the SL communication transmission or the second set of power control parameters for determining the second transmission power of the sensing transmission.

13. The method of claim 11, wherein:
the first transmission power of the UL communication transmission or the SL communication transmission is determined using the first set of power control parameters; or
the second transmission power of the sensing transmission is determined using the second set of power control parameters.

14. The method of claim 11, wherein a parameter or multiple parameters in the second set are dedicated for sensing power control.

15. The method of claim 11, the method for use in interference avoidance of sensing transmissions comprising:
upon detecting interference involving two or more UE, transmitting, by the base station, an indication for at least one UE to adjust UE sensing transmission power, wherein the indication indicates an absolute sensing transmission power or a differential sensing transmission power.

16. The method of claim 15, wherein the indication is transmitted on a UE specific downlink control information (DCI), a group-specific DCI, a media access control-control element (MAC-CE) or a radio resource control (RRC) message.

17. The method of claim 11, the method for use in interference avoidance of sensing transmissions comprising:
transmitting, by the base station, configuration information pertaining to sensing resources used by at least one UE, wherein the configuration information enables a first UE to determine a second priority of a second UE so when interference is detected between the first UE and the second UE, the first UE is configured to compare a first priority of the first UE with the second priority of the second UE.

18. The method of claim 17, wherein the configuration information pertaining to the sensing resources used by the at least one UE indicates at least one priority associated with a sensing resource for at least one of the other UEs.

19. The method of claim 17, further comprising:
transmitting, by the base station, threshold information for use by the first UE during interference mitigation, the threshold information being compared to a sensing transmit power of the first UE that has been exponentially ramped up.

20. The method of claim 17, further comprising:
transmitting, by the base station, priority configuration information for defining the first priority of the first UE.
